(19) United States
(12) Patent Application Publication
(10) Pub. No.: US 2017/0297445 A1
(43) Pub. Date: Oct. 19, 2017

(54) Cone Shaped Docking Mechanism Provides Rigid Connection Between 2 UAVs and Serves as Charging Port to Provide Real Time Charging Power in the air as well as Serves as Ground UAV Charging Stations

(71) Applicant: SHENZHEN FLYEAH INTELLIGENT TECHNOLOGY CO., LTD., Shenzhen (CN)

(72) Inventors: Junxiong ZHENG, Shenzhen (CN); Daniel Yin LIU, Shenzhen (CN); Hongyu RAN, Shenzhen (CN)

(73) Assignee: SHENZHEN FLYEAH INTELLIGENT TECHNOLOGY CO., LTD., Shenzhen (CN)

(21) Appl. No.: 15/132,255

(22) Filed: Apr. 19, 2016

(51) Int. Cl. B60L 11/18; B64F 1/36; B64C 39/02; B64D 5/00

(52) U.S. Cl. CPC B60L 11/1835; B64C 39/024; B64D 5/00; B64F 1/362; B60L 11/1816; B64C 2201/066; B64C 2201/108; B64C 2201/127; B64C 2201/146; B64C 2201/122

(57) ABSTRACT

A cone shaped docking and releasing mechanism provides rigid connection between a parent UAV and a sub UAV to form a spliced double unmanned aerial vehicle system with improved cruising duration ability by providing sub UAV battery with charging function. It comprises a parent UAV, a sub UAV and a docking mechanism with charging ports. The parent UAV and the sub UAV are connected with each other through the docking mechanism to form a double UAV system, the docking mechanism is a cone structure and comprises a charging output component connected with the parent UAV internal control system, a charging circuit connected with a sub UAV control system and a charging input component connected with the charging circuit.

### TECHNICAL FIELD OF THE INVENTION

This docking mechanism is designed especially for A SPLICED DOUBLE UNMANNED AERIAL VEHICLE SYSTEM WITH IMPROVED ENDURANCE ABILITY as well as UAV charge stations.

This disclosure refers to the technical field of aerial vehicle, in particular, but not limited to a spliced double unmanned system with improved endurance ability. It also can serve as UAV ground charging stations.

### BACKGROUND OF THE INVENTION

Unmanned aerial vehicle (UAV) is also known as multi-rotor type aerial vehicle with characteristics, such as, convenience, lightweight, stable flight and low noise. Unmanned aerial vehicle (UAV) with imaging equipment and monitoring equipment provides an effective means for undercover investigation, especially in an area people cannot easily approach. Unmanned aerial vehicle can provide first-hand video materials.

It is reported that a research group from Texas University found a new unmanned aerial vehicle (UAV) application, which is emergency communication. The group develops an unmanned aerial vehicle communication system, which is able to provide WiFi for the disaster area. The cover area can reach 5 km. It is understood that, the cover area of ordinary WiFi antenna is limited to 100 m radius. However, the antenna used by the group is a directive antenna, which is able to detect the target automatically and provide accurate and stable signal for the target. The directive antenna also shows extraordinary performance in anti-interference.

Currently, the war of unmanned aerial vehicle network service between Google and Facebook is realized quietly in the army. A team of unmanned aerial vehicle served in Iraq is assigned to a new task: providing WiFi at remote battlefields. Unmanned aerial vehicle RQ-7 shadow plays a role of reconnaissance, surveillance, target acquisition and battle damage assessment. But now, they have become the best wireless router in the world. In remote battlefield, communication is a big problem. Poor communication may mean defeat by enemies. Unmanned aerial vehicle used as a WiFi main center is configured to be a supplement for the limitation of wireless signal and to increase data transmission channels.

However, the biggest problem of unmanned aerial vehicle is the consumer market is the cruising ability. The cruising duration of the civil unmanned aerial vehicle system is about 20 minutes; the cruising duration of the unmanned aerial vehicle system used in some industries is only up to 1-2 hours. Furthermore, there is no technology about long cruising duration or infinite cruising duration on the market. Especially in military unmanned aerial vehicles with WiFi technology, if the unmanned aerial vehicles need to be charged after being used for 20 minutes, the Wifi signal or internet signal will be broken off.

Currently, there is a patented technology about endurance of UAV, when a first UAV's power is running low, a second UAV is started to perform the same task. At the same time, the first UAV returns to the starting place or a specific charging place to be charged. When the charging is finished, the first UAV takes off and the second UAV returns to be charged. Circulating like this, the purpose of extending the endurance time is achieved. Of course, when the first UAV is being charged, manual recharging can be used. A machine vision technology can also be used to enable the UAV find the charging preparation place and return to be charged automatically. Contact charging or non-contact wireless charging can be used.

However, regardless of the methods stated above, when performing critical tasks, problems like breaking off and discontinuity always exist, because the first UAV and the second UAV do not connect with each other. The position where the first UAV's power urns out is not the exact position the second UAV arrives at. Therefore, this technology has the defect of inaccuracy in cruising position.

At the same time, this technology also has defect of task separation. For example, when the first UAV is shooting key videos or images, unfortunately, the first UAV's power runs out, the first UAV can only return to launch site for charging along with the camera. The second UAV with another camera takes off to continue performing the task. The details in the video are interrupted and the video materials shot by two independent cameras must be united and processed. Uniting videos is also very tedious and it is easy to lose key information.

Furthermore, two separate UAVs with the same load are unable to increase the cruising duration. Two separate UAVs with the same cruising duration are unable to achieve a heavier load. Therefore, existing UAV's cruising duration and load are unable to change flexibly.

For UAV automatic charging station, no matter it is contact or contactless charging station, often that the interconnection between a UAV and charging station is not precise and as a result, the contactless charging station may not provide enough charge power due to misalignment between charge pad and a UAV. For contact charging station, it needs to have multiple large expansive pieces of metal contacts designed to the landing pads. These exposed metal contacts will have fire risk due to metal debris could fall on the charging pads and cause short circuit. By using our cone shaped docking and releasing charge mechanism it provides precise connection and therefore it will eliminate this risk since the contacts are relatively small, inexpensive and vertically installed. Also, the charge station can be designed to be accessed from below which will eliminate the risk completely.

### SUMMARY OF THE INVENTION

The present invention is a cone shaped docking and releasing mechanism which provides rigid connection between a parent UAV and a sub UAV to form a spliced double unmanned aerial vehicle system with improved cruising duration ability by providing sub UAV battery power module with charging function in the system. By using this cone shaped docking and releasing mechanism, parent UAV and sub UAV joint together reliably and they can fly together like a single UAV. But also, both UAV can be separated with ease. This cone shaped docking and releasing mechanism can also be implemented as part of ground charging docking pads for UAV. It solves the existing UAVs' problems of cruising duration, task interruption and inaccuracy of position when using two independent UAVs to execute tasks under long endurance and the problem that existing UAV's endurance time and load are unable to change flexibly.

In order to solve the problems as described in the background technology, the present invention uses technical solution as below: it comprises a parent UAV, a sub UAV and a cone shaped docking mechanism, the parent UAV and the sub UAV are connected with each other through the cone shaped docking mechanism to form a double UAV system.

The docking mechanism comprises an inner cone shaped docking control mechanism which is fixed to the lower part of the parent UAV and an outer cone shaped docking plug which is fixed to the upper part of the sub UAV (or the other way, an outer cone shaped docking control mechanism is fixed to the lower part of the parent UAV and an inner cone shaped docking plug is fixed to the upper part of the sub UAV); the outer cone shaped docking plug is matted with an inner cone surface of the docking mechanism in a plug-in way; the docking control mechanism comprises a imaging system, e.g. a near field Intel realsense 3D camera module and a far field Intel realsense 3D camera module, a docking/releasing mechanism and a sensor component configured to detect whether the docking plug is in place; the docking/releasing mechanism and the sensor component are electrically connected with a parent UAV internal control system; the docking/releasing, mechanism is droved by a gear reduction servo motors. The docking control mechanism system also comprises charging ports assembly designed to engage with the charging input ports on the sub UAV to provide the sub UAV battery charging power. A charging circuit electrically is independently connected between the sub UAV battery and charging input ports.

The parent UAV system comprises a parent UAV CPU mainboard, a parent UAV battery power source, a parent voltage-current sensor module, a parent UAV GPS receiver and compass combo module, a docking/releasing linear actuator motor control module, a parent UAV telemetering radio transceiver module, a parent UAV radio control receiver module and the two Intel Realsense Camera Modules (one is near field and other is far field). All the parent UAV modules are electrically connected with the parent UAV CPU mainboard; the telemetering radio transceiver module and the radio control receiver module are separately connected with an antenna; a docking success sensor module is electrically connected with the docking/releasing motor control module; each parent UAV rotor wing motor is electrically connected with their corresponding electronic speed control (ESC) module, the ESCs are electrically connected with the parent UAV CPU mainboard and the parent UAV battery power source E1.

The sub UAV system comprises of a sub UAV CPU mainboard, a sub UAV battery power module, a sub UAV voltage and current sensor module, a sub UAV GPS receiver and compass combo module, an Intel realsense camera module, a sub UAV telemetering radio transceiver module and a sub UAV radio control receiver module. All the sub UAV modules are electrically connected with the sub UAV CPU mainboard; the sub UAV telemetering radio transceiver module and sub UAV radio control receiver module are separately connected with an antenna, a task executing device installed on a lower end of the sub UAV is electrically connected with the sub UAV CPU mainboard and the sub UAV battery power module; each sub UAV rotor wing motor is electrically connected with their corresponding electronic motor speed control (ESC) modules; the ESCs are electrically connected with the sub UAV CPU mainboard and its own battery power supply.

As a further improvement for the present invention, the parent UAV is a bigger aircraft, the sub UAV is either a smaller aircraft or as big as the parent UAV.

The working process of the present invention comprises:

First, a docking process of the parent UAV and the sub UAV comprises:
(1) keeping the sub UAV hovering at a certain height and stable, the parent UAV flies up above the sub UAV, the sub UAV keeps still;
(2) a camera (for example, an Intel farfield realsense 3D and near field camera modules) installed on a lower part of the parent UAV are used for image recognition, machine vision technology is adopted to find the sub UAV and its docking plug located on top of the sub UAV, when the parent UAV finds an accurate position of sub UAV or its docking plug, the parent UAV flies above the sub UAV and descends vertically;
(3) after the docking plug is inserted into the docking shell, once the control system detects that the vertical distance of the two UAV is less than a preset value or a height of the docking mechanism, the control system adjusts to a docking flight mode to finish docking;
(4) when a docking success sensor module detects that the docking plug is in place, the docking success sensor module sends a signal to the microcontroller to start a servo motor to lock the docking plug;
(5) when the docking system is in a locked position, both positive and negative charging electrodes on the parent drone are connected with respect to the positive and negative charging input electrodes on the sub-drone. Therefore, charging the sub UAV through the parent UAV is achieved;

Second, a separation process of the parent UAV and the sub UAV comprises:
(I) starting the sub UAV's rotors with preset hovering power before releasing;
(II) sub UAV delays a few seconds by the time its rotor can support its own weight and mounted task execution devices, the sub UAV sends an order to the parent UAV;
(III) the parent UAV starts the servo motor and releases the docking plug;
(IV) the parent UAV and the sub UAV separates slowly; in the separating process, the parent UAV hovers at a certain height and keeps still while the sub UAV departs from the parent UAV;
(V) the sub UAV can also hover at a certain height and keep still to ensure the mounted task execution devices to work continuously without interruption while the parent UAV flies up slowly, departs the docking mechanism, and returns to ground for changing its battery or for replacing its battery;

Third, when the parent UAV malfunctions in the process of executing task, the sub UAV can carry the parent UAV back to the ground, which increases the stability of the system;

Fourth, repeating the docking process and the separating process achieve the purpose of long cruising duration and aerial charging of the double UAV system.

Beneficial Effects of the Invention:

1. The present invention solves the endurance problem of existing UAV system, besides, aerial charging is realized. No matter which kind of UAV is being used, the cruising duration can be improved when executing tasks with this invention.

2. The present invention overcomes the defects of task interruption and location inaccuracy in long-endurance mission of existing technology by using two separate UAVs.

3. The present invention overcomes the defects of endurance time and load is unable to change flexibly.

### BRIEF DESCRIPTION OF THE DRAWINGS

FIG. 1 is a structure diagram of the present invention.

FIG. 2 is a schematic circuit diagram of Docking/Releasing Linear Actuator Motor Control Module invention.

FIG. 3 is a structure diagram of the top view of the invention, an aerial charging docking mechanism, in locking status;

FIG. 4 is a sectional view of FIG. 3.

FIG. 5 is a sectional view of FIG. 4 from the right.

FIG. 6 is a structure diagram of the invention, the aerial charging docking mechanism, in releasing status;

FIG. 7 is a top view of FIG. 6.

FIG. 8 is a sectional view of FIG. 7 from the right.

FIG. 9 is a block diagram of the parent UAV's control system of the invention.

FIG. 10 is a block diagram of the sub UAV's control system of the invention.

FIG. 11 is a flow chart of the invention.

### DETAILED DESCRIPTION OF THE INVENTION

In order to clarify the intention, technical solution and advantages of the invention, a detailed description of the present invention is presented in conjunction with the drawings and the specific embodiment. It should be understood that, the specific embodiment is only used to describe rather than limit the present invention.

### Embodiment

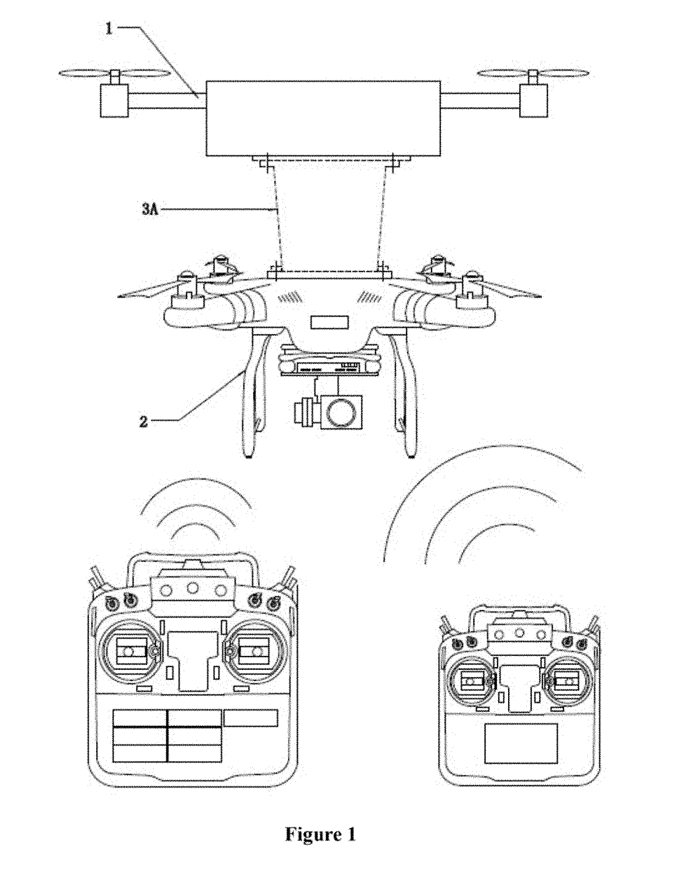

Referring to FIG. 1, parent UAV 1 and sub UAV 2 are connected to each other through aerial charging and docking mechanism 3A to form a double UAV system. Aerial charging and docking mechanism 3A comprise docking control mechanism A, which is fixed to the lower part of parent UAV 1, and docking plug 6, which is fixed to the upper part of sub UAV 2.

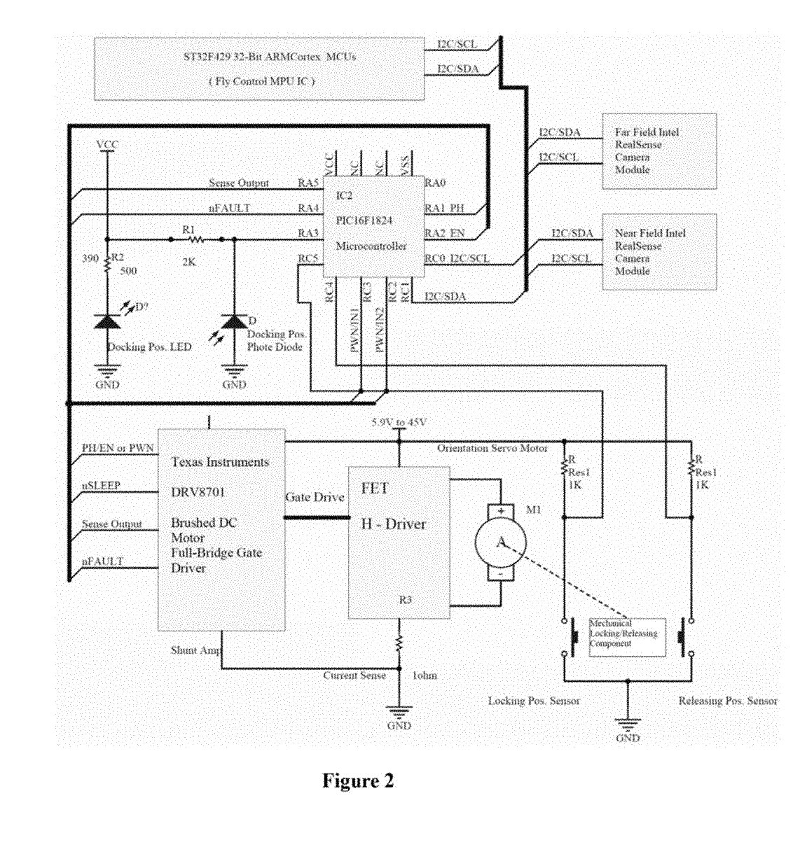

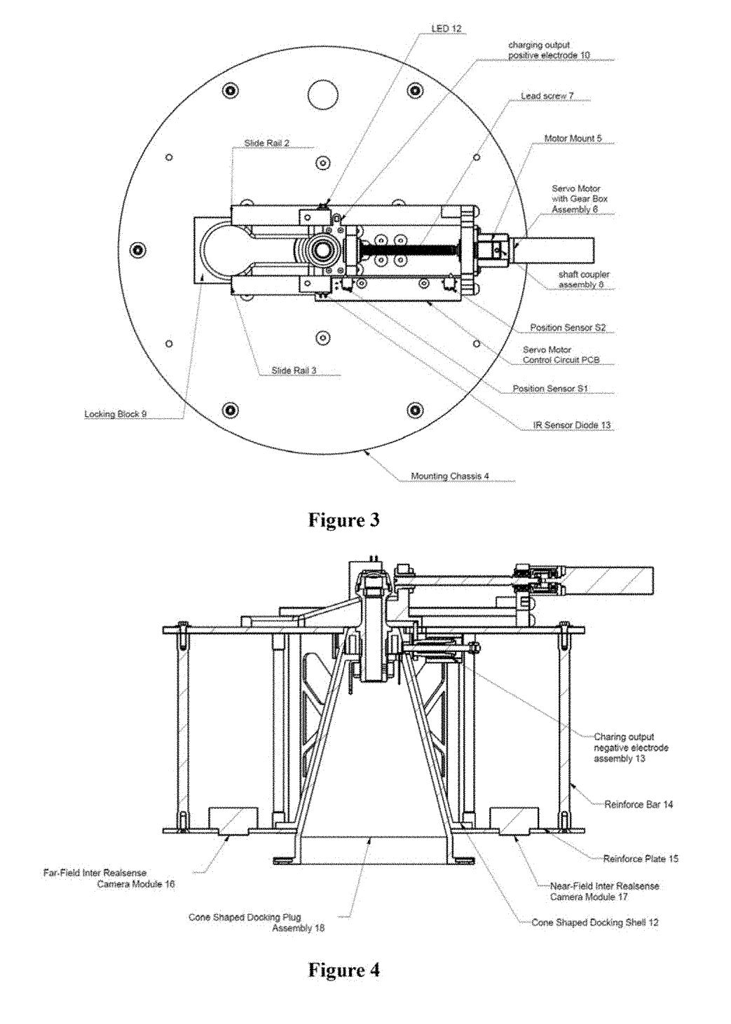

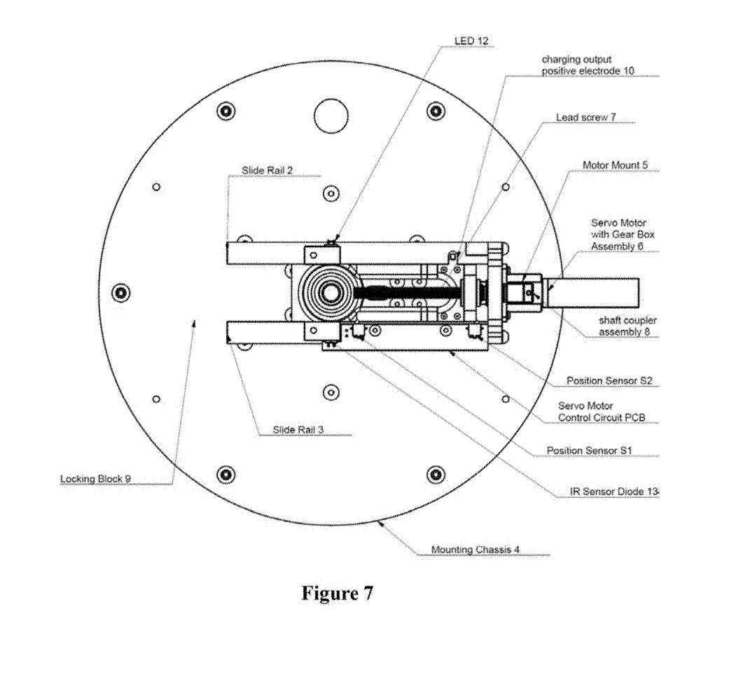

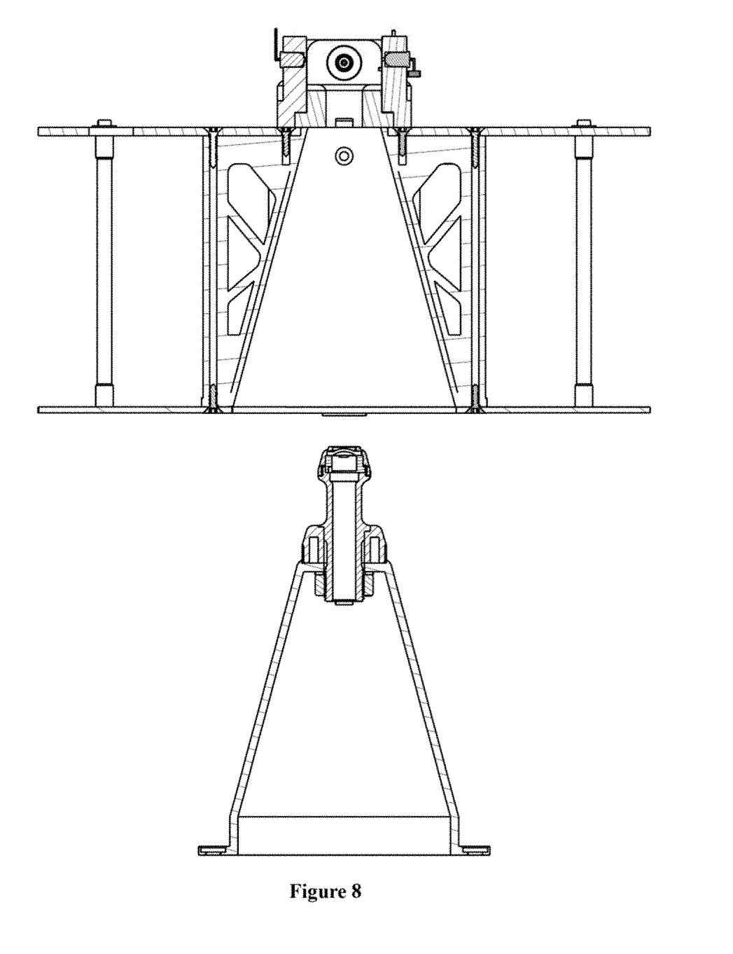

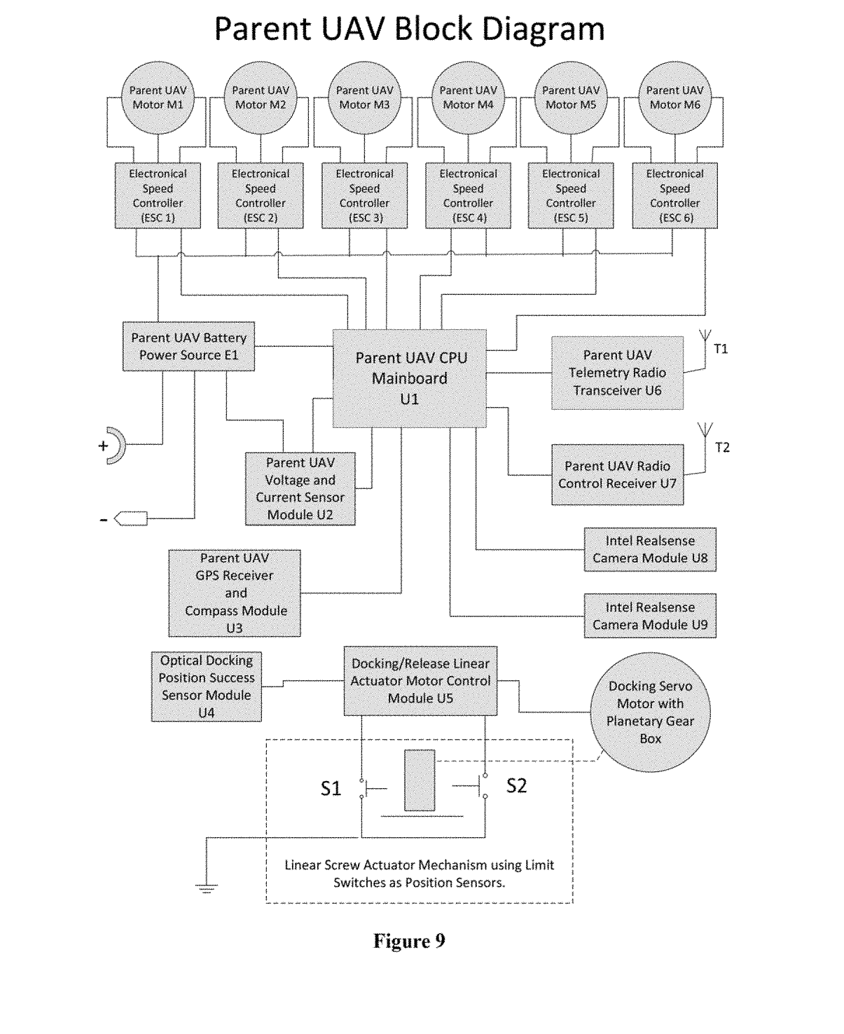

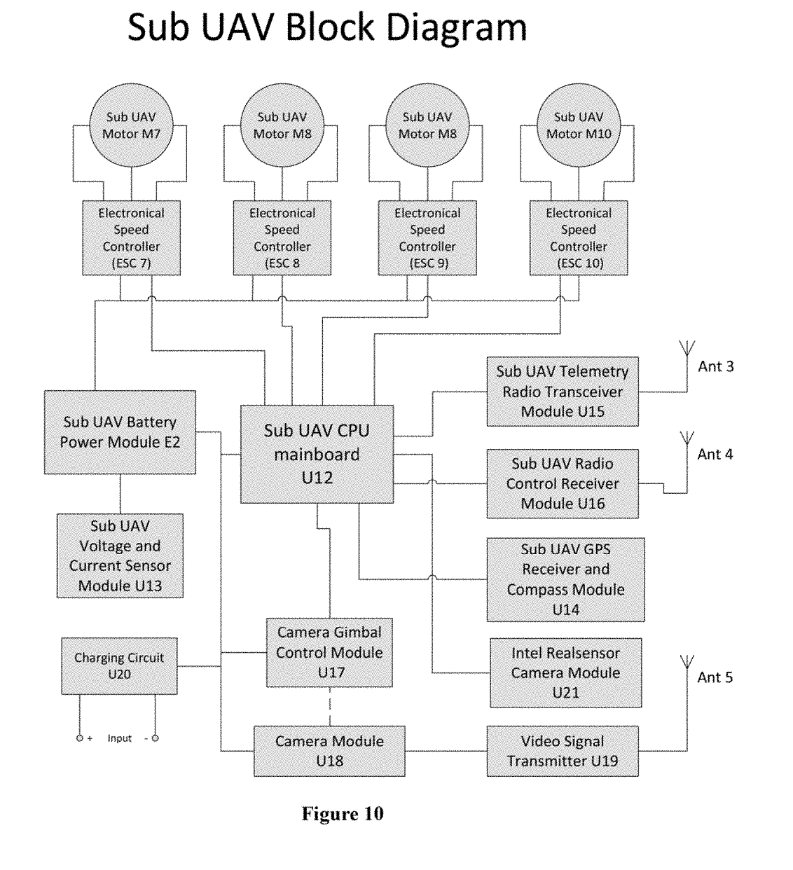

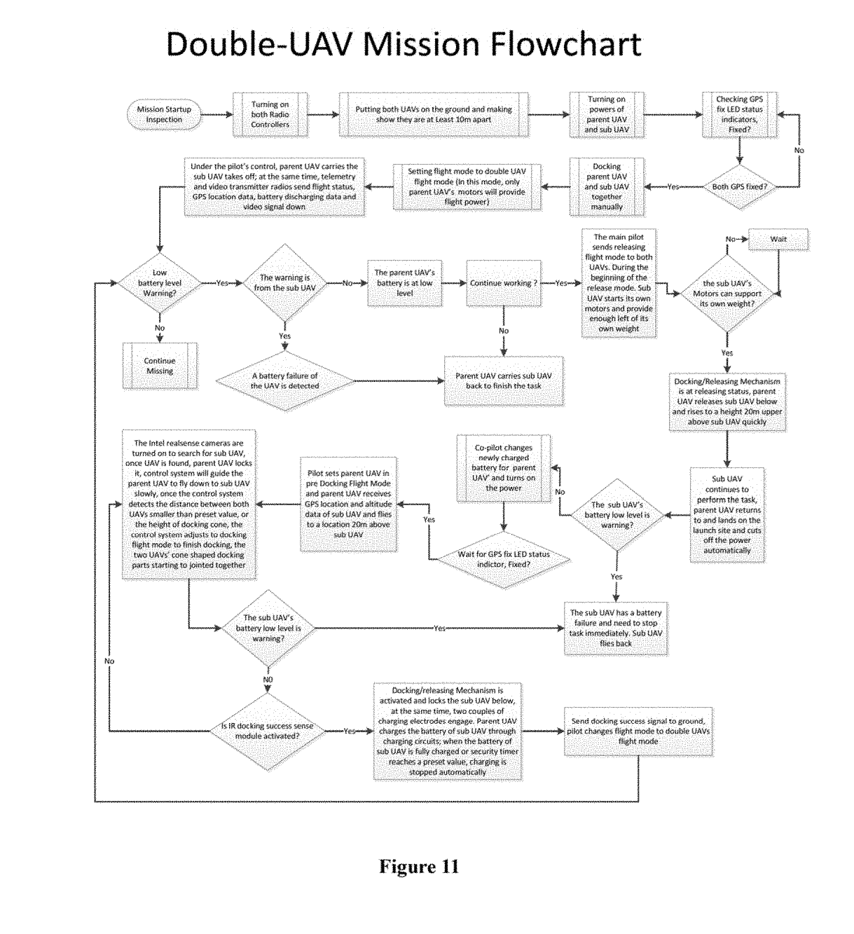

Referring to FIGS. 2-8, docking control mechanism is driven by a linear screw actuator. It comprises mounting chassis 4. The upper surface of mounting chassis 4 is installed with two slide rails 2 & 3. The ends of the two slide rails are installed with a motor mount 5 and a servo motor with gear box assembly. A lead screw 7 is drive by the servo motor output gear box output shaft through a shaft coupler assembly 8. The lead screw will bring locking block 9 to either locking or release position. Charging output component positive electrode 10 is installed on locking block 9. One side of the slide rail is installed with servo motor control circuit PCB 11 with two switch position sensors S1 and S2 solder on it. Both IR sensor and LED are inserted into the mounting holds on the slide rail sides respectively. The lower end of mounting chassis 4 is screwed onto the cone shaped docking shell 12. Charging output negative electrode assembly 13 is push the negative electrode to the charging position during docking process. The charging output negative electrode will be automatically disengaged by the spring force built in the negative electrode assembly. A reinforce plate is screw onto the cone shaped docking shell to provide support through 6 reinforcement bars. Two Intel Realsense camera modules 16 & 17 are mounted on to the reinforce plate.

Referring to FIG. 8, docking plug 6 is cone shaped assembly. An upper end of docking plug 18 is vertically set metal head 19. An Intel realsense camera module 21 is inserted into the metal head 19. A lower end of metal head 13 is installed with charging input component positive electrode 2. Between up cone shaped part 23 and lower cone shaped part 18 are screwed together with thread on metal head assembly with a nut. Between them a negative charging ring with negative charging input electrode was inserted.

Limit switch position sensor switches S1 and S2 are separately located at an initial end and terminal end of slide rail 3.

Optical docking success sensor module comprises a LED light source and an IR sensor diode 13.

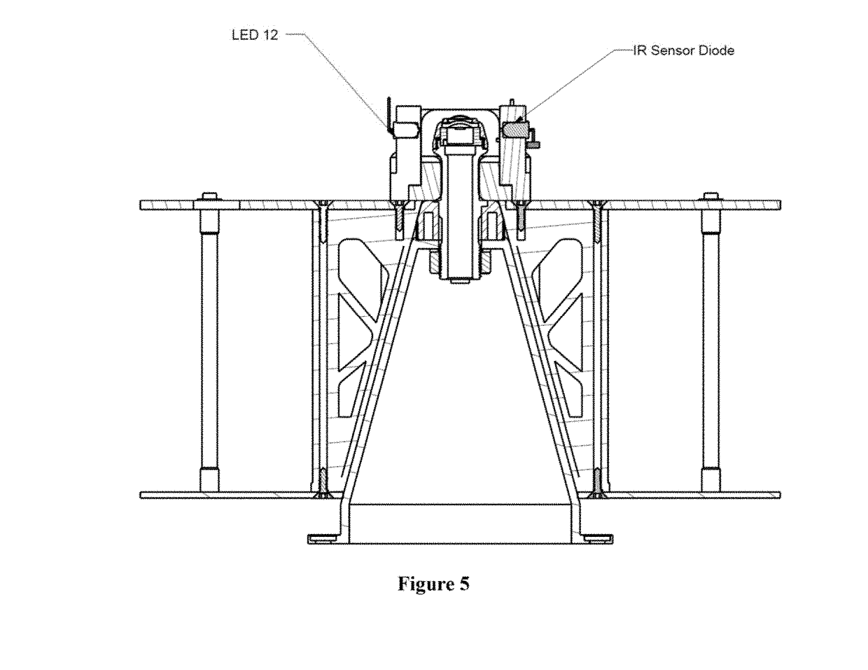

Referring to FIGS. 4 & 9, charging output component negative electrode on the charging output negative electrode assembly 13 and charging output component positive electrode 10 are both connected to parent UAV battery power source E1 of the parent UAV control system. Optical docking success sensor module U4, limit position sensor switches S1 and S2, and motor connected to docking/releasing linear actuator driver control module U5 of the parent UAV control system.

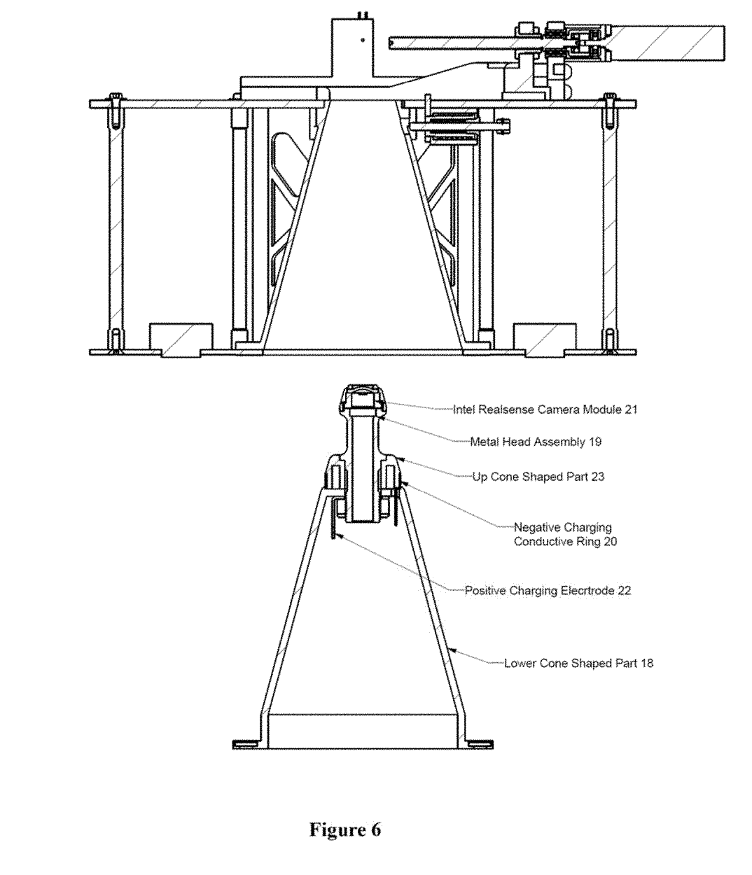

Referring to FIGS. 6 & 10, charging input component negative electrode 20 and charging input component positive electrode 22 are both connected to charging circuit U20 of sub UAV's 2 control system. Charging circuit U20 is connected to sub UAV battery power module E2 of sub UAV 2.

The principle of the embodiment is described as below: parent UAV 1 and sub UAV 2 fly to a position after docking successfully. At this time, the propellers of parent UAV 1 rotate and propellers of sub UAV 2 located under the parent UAV is not started. After flying to the working place, when battery level of parent UAV 1 is low; propellers of sub UAV 2 start, parent UAV 1 releases sub UAV 2 located under the parent UAV. Sub UAV 2 works independently. Parent UAV 1 returns to ground for changing the battery. After parent UAV gets new battery, parent UAV 1 flies up above sub UAV 2 again, then docks with sub UAV 2. After docking successfully, propellers of sub UAV 2 stop rotating for saving power, then parent UAV 1 charges the battery of sub UAV 2 for recovering the energy loss. The whole docking process will spend no more than 5 minutes; electric energy loss of sub UAV 2 is minimum. The battery capacity of sub UAV 2 just needs to support for about 5 minutes, then a successful docking process will be guaranteed. Parent UAV 1 charges sub UAV 2 for about 10 minutes, the electric energy loss during the docking process will be compensated. In this process, propellers of sub UAV 2 are kept stationary. After sub UAV 2 is fully charged, until battery level of parent UAV 1 is at low level, parent UAV 1 returns to ground for changing battery. Repeating all these steps, the cycle repeats to achieve a long cruising duration.

Referring to FIG. 19, the process the embodiment is below:
a. inspecting parent UAV 1 and sub UAV 2 before starting a task;
b. turning on two radio controllers;
c. putting parent UAV 1 and sub UAV 2 on the ground with a distance ranging from 10 to 20 m apart, turning on powers of parent UAV 1 and sub UAV 2;
d. waiting and checking GPS fix status LED on GPS receiver and compass combo modules for both UAVs; after the GPS fixing on both UAVs, docking both UAVs together manually;
e. setting flight mode switch to double UAV flight mode by a pilot (in this mode, only parent UAV's motors provide flight power);
f. under the pilot's control, parent UAV 1 carries sub UAV 2 and takes off; at the same time, flight status, GPS location data, orientation and video signal of two UAVs are sent by telemetering radio transceiver modules (in the task, the co-pilot can also control parent UAV 1 to take off)
g. during the flight, the parent voltage-current sensor module and the sub voltage-current sensor module monitor battery levels of parent UAV 1 and sub UAV 2 in real time. If sub UAV's battery level is at low level, the pilot can decide whether parent UAV 1 should continue working or not. If the pilot lets parent UAV 1 to continue working, parent UAV 1 will carry sub UAV 2 back when it warns that the parent UAV battery power source is low. If the pilot lets parent UAV 1 to stop working, parent UAV 1 will carry sub UAV 2 back directly to finish the task right way;
h. when parent UAV 1 warns for low battery and does not need to continue to perform a task, parent UAV 1 will carry sub UAV 2 back directly, then task is finished. When parent UAV 1 warns for low battery and needs to continue to perform a task, the pilot sends pro releasing flight mode signal to the two UAVs and starts sub UAV's motors to support its own weight;
i. when docking/releasing linear driver motor control module U5 is at releasing status, parent UAV 1 releases sub UAV 2 below and rises to a height of 15-25 m above sub UAV 2 quickly, sub UAV 2 continues to perform the task, parent UAV 1 returns to launch site and cuts the power off automatically;
j. the co-pilot changes new rechargeable batteries for parent UAV 1 and turns on the power and waits for GPS fix;
k. after GPS fix, the pilot sets parent UAV 1 to pro docking flight mode, parent UAV 1 receives GPS location and height data of sub UAV 2 and flies to a location 20 m above sub UAV 2;
l. the Intel realsense 3D camera modules are turned on to search sub UAV 2, once sub UAV 2 is found, parent UAV 1 locks it; control system will guide parent UAV 1 to fly to sub UAV 2 slowly; once the control system detects that distance between the 2 UAVs is less than a preset value or the height of the cone shaped docking plug, the control system adjusts to docking flight mode to finish docking,
m. if sub UAV 2 warns for low battery, then sub UAV 2 stops the task and returns; if sub UAV 2 does not warn for low battery, then sub UAV 2 continues working. Optical docking success sensor module U4 checks whether the docking plug is in place;
n. if the docking plug is in place, the docking mechanism is activated and it locks sub UAV 2 below, at the same time, two couples of charging electrodes engage, parent UAV 1 provide charging power for the battery on the sub UAV 2 through charging circuit U20; when the battery of sub UAV 2 is fully charged or security timer reaches a preset value, charging is stopped automatically; if the docking plug is not in place, then repeats step l;
o. telemetry radio U6 sends the docking success signal to ground, the pilot changes the flight mode to double UAVs flight mode;
p. repeating and circulating from steps g to step o can realize the control of the double UAV system.

The aerial charging spliced double UAV system stated by the above specific embodiments can solve the endurance problem of existing UAV system, no matter which kind of UAV it is, the endurance time can be improved during executing tasks. In particular, the present invention can be used to provide a WiFi base station for a long time or provide a mobile operator base station to provide an internet system; defects like task dissociation and location inaccuracy can be overcome. The defect of inability to change endurance time and load flexibly can also be overcome.

The above description is preferred embodiments of the present invention. The present invention is not limited to the description stated above. Equal modifications or replacements according to the technical solutions of the present invention are also within the scope of this application, especially for the other use of the cone shaped docking and releasing mechanism.

1. The cone shaped docking and releasing mechanism provides rigid connection between two UAVs to form a spliced double unmanned aerial vehicle system and serves as charging port to provide real time charging power in the air, comprising: a cone shaped docking and releasing mechanism with integrated charging port assembly, a parent unmanned aerial vehicle (UAV), a sub UAV; wherein the parent UAV and the sub UAV are connected with each other through the docking and releasing mechanism to form a double UAV system.

2. The formed spliced double UAV system with improved endurance ability of claim 1, wherein the docking mechanism comprises a docking control mechanism integrated with charging port assembly which is fixed to the lower part of the parent UAV, and a cone shaped docking plug which is fixed to the upper part of the sub UAV; the docking plug integrated with charging port is connected with a docking shell of the docking mechanism in a plug-in way; the docking control mechanism comprises a plurality of imaging components, a docking/releasing mechanism and a sensor component configured to detect whether the docking plug is in place; two imaging components, the docking/releasing mechanism and the sensor component are electrically connected with a parent UAV internal control system; the docking/releasing mechanism is driven by the servo motor through a planetary reduction gearbox.

3. The formed spliced double unmanned aerial vehicle system with an improved endurance ability of claim 1, wherein the parent UAV control system comprises a parent UAV CPU mainboard, a parent UAV battery power source, a parent voltage-current sensor module, a parent UAV GPS receiver and compass combo module, a docking/releasing motor control module, a parent UAV telemetering radio transceiver module, a parent UAV radio control receiver module and two camera modules, which are all electrically connected with the parent UAV CPU mainboard; the parent UAV telemetering radio transceiver module and the parent UAV radio control receiver module are separately connected with an antenna; a docking success sensor module is electrically connected with the docking/releasing motor control module; each parent UAV rotor wing motor is electrically connected with a ESC corresponding to the parent UAV rotor wing motor, the ESC modules are electrically connected with the parent UAV CPU mainboard and the parent UAV battery power source; wherein the charging ports are electrically connected with the parent UAV battery power source.

4. The formed spliced double unmanned aerial vehicle system with an improved endurance ability of claim 1, wherein the sub UAV control system comprises a sub UAV CPU mainboard, a sub UAV battery power module, a sub UAV voltage-current sensor module, a sub UAV GPS receiver and compass combo module, a sub UAV telemetering radio transceiver module and a sub UAV radio control receiver module, which are all electrically connected with the sub UAV CPU mainboard; the sub UAV telemetering radio transceiver module and the sub UAV radio control receiver module are separately connected with an antenna, a task executing device installed on a lower end of the sub UAV is electrically connected with the sub UAV CPU mainboard and the sub UAV battery power module; each sub UAV rotor wing motor is electrically connected with a ESC module corresponding to the sub UAV rotor wing motor; the ESCs are electrically connected with the sub UAV CPU mainboard and the sub UAV battery power module.

5. The formed spliced double unmanned aerial vehicle system with an improved loading ability of claim 1, wherein: the parent UAV is a bigger aircraft, the sub UAV is either a smaller aircraft or as big as parent UAV; the parent UAV's rotor wing and the sub UAV's rotor wing are configured to start at the same time.

6. The formed spliced double unmanned aerial vehicle system with an improved endurance ability of claim 1, wherein: the parent UAV's rotor wing and the sub UAV's rotor wing are staggered from each other and start independently; if only one UAV's propellers are started, load is reduced but endurance time is increased, which are changed flexibly.

7. A docking process for the parent UAV and the sub UAV of claim 1, comprising the following steps:
S11 keeping a sub UAV hovering at a certain height, a parent UAV flies up above the sub UAV, the sub UAV keeps still;
S12 installing a far field camera module on a lower part of the parent UAV for image recognition, wherein a machine vision technology is adopted to find the sub UAV and its docking plug located at an upper end of the sub UAV, once the far field camera is out of focus range, a near field 3D camera kicks in and continues to provide locking on image of the docking plug. Whenever the parent UAV finds an accurate position of the docking plug, the parent UAV flies to upward side of the sub UAV and descends vertically;
S13 after a docking plug is inserted into a docking shell, adjusting the control system to a docking flight mode to finish docking once the control system detects distant is less than a preset value or a height of the docking mechanism;
S14 sending a signal to start a servo motor and lock the docking plug after the optical docking success sensor module senses the docking plug is in place;
S15 charging the sub UAV by the parent UAV when the docking is in place, wherein the charging output assembly positive electrode is electrically connected with the charging input component positive electrode, the charging output assembly negative electrode is electrically connected with the charging input component negative electrode;

8. A separating process for the parent UAV and the sub UAV of claim 1, comprising the following steps:
S21 starting the sub UAV's rotor wing before releasing;
S22 when the sub UAV can support its own weight and mounted task execution devices, the sub UAV sends an order to the parent UAV;
S23 the parent UAV starts the servo motors and releases the docking plug;
S24 the parent UAV and the sub UAV separates slowly, in the separating process, the parent UAV hovers at a certain height and the sub UAV departs;
S25 the sub UAV can also hover at a certain height to ensure the mounted task execution devices to work continuously without interruption, the parent UAV flies up slowly, departs the docking mechanism, and returns to ground for changing battery or for charging of the battery;
wherein when the parent UAV malfunctions during the task, the sub UAV carries the parent UAV or provide assistant lift force to return to the ground, which increases the safety of the system; wherein repeating the docking process and the separating process achieves the purpose of long endurance time and aerial charging of the double UAV system.

9. The cone shaped docking and releasing mechanism serve as either a fixed ground charging station or a charging pole design of claim 8, especially using cone shaped parts derived from this mechanism.

10. The docking process of the parent UAV and the sub UAV according to claim 7, wherein the process further comprises the following step: hovering the parent UAV at a certain height and docking the sub UAV to the parent UAV from the beneath of the parent UAV using an Intel realsense camera module and a control software on the sub UAV; wherein the Intel realsense camera module is configured to detect parent UAV above and locks on it, the control software takes control sub UAV flies towards parent UAV above; once IR docking success sense module of the parent UAV is activated, or detects docking plug in place, the parent UAV takes over and finishes the docking process.
